(19) United States
(12) Patent Application Publication
(10) Pub. No.: US 2025/0138133 A1
(43) Pub. Date: May 1, 2025

(54) Detecting a Presence of an Active Tag Attached to a Battery within a Bin Received by a Vehicle

(71) Applicant: Bayshore Recycling Services LLC, Atlantic Highlands, NJ (US)

(72) Inventors: Daniel M. Dobkin, Sunnyvale, CA (US); Tali Freed, Atascadero, CA (US); Duncan Culver, Howell, NJ (US)

(73) Assignee: Bayshore Recycling Services LLC, Atlantic Highlands, NJ (US)

(21) Appl. No.: 18/930,674

(22) Filed: Oct. 29, 2024

Related U.S. Application Data
(60) Provisional application No. 63/629,495, filed on Oct. 30, 2023.

(51) Int. Cl. G01S 5/02

(52) U.S. Cl. CPC G01S 5/0269

(57) ABSTRACT

Apparatuses, methods, and systems for detecting the presence of a beacon are disclosed. An embodiment includes a vehicle that includes a load arm configured to receive a bin, a first detector configured to receive a first wireless signal when the load arm is in a first position, and receive a second wireless signal when the load arm is in a second position, a second detector configured to receive a third wireless signal when the load arm is in the first position, and receive a fourth wireless signal when the load arm is in the second position, and a controller configured to detect presence of the beacon attached to an object within the bin based on the received signal strengths of the first wireless signal, the second wireless signal, the third wireless signal and the fourth wireless signal.

### RELATED PATENT APPLICATIONS

This patent application claims priority to Provisional Patent Application Ser. No. 63/629,495 filed Oct. 30, 2023, which is herein incorporated by reference.

### FIELD OF THE DESCRIBED EMBODIMENTS

The embodiments described relate generally to detection of batteries. More particularly, the embodiments described relate to systems, methods, and apparatuses for detecting the presence of an active tag attached to a battery within a bin received by a vehicle.

### BACKGROUND

The use of lithium ion batteries of varying chemistries is extensive and rapidly expanding, due to their high energy density per unit mass, good charging behavior, and long endurance. Because the lithium reacts readily with water, and battery operating voltage exceeds the ionization threshold of water, aqueous electrolytes cannot be used. As a consequence, most lithium ion batteries employ flammable organic compounds in their electrolytes. Any stress or mechanical damage that causes a localized short circuit and release of electrical energy may induce combustion of the electrolyte. Ignition may also result from thermal runaway, due to complex reactions taking place within the battery. If other flammable materials are in the vicinity of the battery at this time, a fire may result. Batteries may remain flammable long after the last normal charging operation.

The increasing employment of such batteries results in increasing numbers of lithium ion batteries in waste and general recycling streams, disposed of individually or still incorporated in cellular phones, laptop computers, or other battery-powered hardware. Recycling collectors typically employ trucks to collect recycling material from bins or dumpsters. The trucks then supply the materials to a sorting and processing facility. Lithium batteries can ignite due to thermal runaway or mechanical damage when within a truck, representing a potential danger to the driver and surrounding people and property. Even when it is sufficient to dump the truck contents and manually remove and extinguish the flammable materials, considerable time and cost are incurred, and such fires always present a risk of damage to the truck and surroundings, and a danger to the driver and nearby people. Particularly in the case where a single recycling stream must be processed, recycling processors must rapidly sort large amounts of solid materials delivered by large trucks of varying configuration. FIG. 1 shows a delivery truck 106 that dumps a recycling stream 108 on a tipping floor 100, and the delivered recycling stream 104 is transferred by a front loader 102 to conveyorized transport and sorting operations, according to the prior art. The approach of FIG. 1 includes dumping the recycling stream from each truck onto a large flat tipping floor 100, often in an enclosed area. The stream materials (previously delivered recycling stream 104) are then picked up by a front-end loader 102 or other handling equipment, and transferred to conveyorized handling streams for processing and separation. The supply trucks and loaders are both heavy vehicles with hard wheels, and can easily damage batteries during handling. Fires can result from this damage, either at the time of loading or after varying delays. Fires caused by lithium batteries are thus an increasing hazard in recycling operations, as described in US EPA report #EPA 530-R-21-002.

Lithium batteries and devices containing lithium batteries can be detected visually by human operators or by cameras using advanced image processing, but accurate identification is complex, and in a large waste stream there is often no line of sight to a large fraction of the total volume of the stream. Other techniques, such as magnetic induction, have been explored for battery detection, but cannot easily be implemented on the tipping floor. Detection at conveyorized handling stations is more readily performed, but is too late to protect the facility from fires on the tipping floor. Therefore, an improved method of lithium ion battery detection and classification is required to protect recycling and waste handling facilities.

It is desirable to have methods, apparatuses, and systems for detecting the presence of an active tag attached to a battery within a bin received by a vehicle.

### SUMMARY

An embodiment includes a vehicle. The vehicle includes a load arm configured to receive a bin, a first detector oriented relative to the load arm to receive a first wireless signal when the load arm is in a first position, and receive a second wireless signal when the load arm is in a second position, a second detector oriented relative to the load arm to receive a third wireless signal when the load arm is in the first position, and receive a fourth wireless signal when the load arm is in the second position, and a controller configured to detect presence of an active beacon attached to a specific object within the bin based on the received signal strengths of the first wireless signal, the second wireless signal, the third wireless signal and the fourth wireless signal.

Another embodiment includes a method of detecting the presence of an active beacon attached to a specific object within a bin received by a load arm of a vehicle. The method includes receiving, by a first detector of a vehicle, a first wireless signal when the load arm of the vehicle is in a first position, receiving, by the first detector, a second wireless signal when the load arm is in a second position, receiving, by a second detector of the vehicle, a third wireless signal when the load arm is in the first position, receiving, by the second detector, a fourth wireless signal when the load arm is in the second position, and detecting, by a controller, the presence of an active beacon attached to a specific object within the bin based on the received signal strengths of the first wireless signal, the second wireless signal, the third wireless signal and the fourth wireless signal.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a delivery truck that dumps recycling stream on a tipping floor, and the recycling stream is transferred by front loader to conveyorized transport and sorting operations, according to the prior art.

FIG. 2 shows a typical example of voltage versus state of charge, according to an embodiment.

FIG. 3 shows the behavior of conventional 18650 battery cells as the temperature is ramped at a slow rate (2° C. per minute in this case), according to an embodiment.

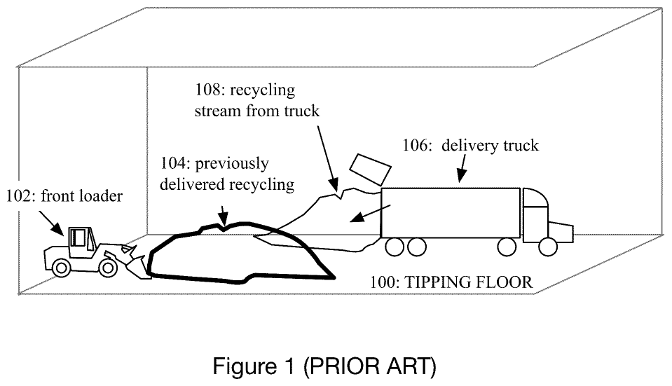

FIG. 1 show an internal battery resistance for Panasonic 18650 lithium ion cell, according to an embodiment.

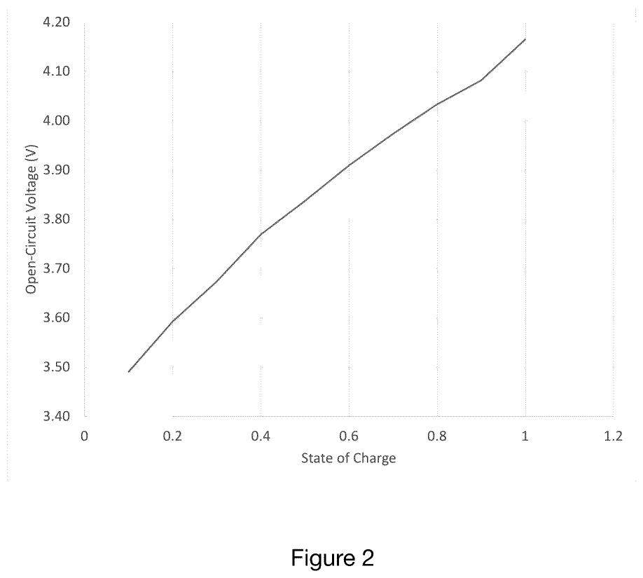

FIG. 2 shows an exemplary beacon and antenna mounted on a typical lithium ion pouch battery, according to an embodiment.

FIGS. 6(a) and 6(b) show a vehicle that is configured to detect the presence of an active beacon attached to a specific object within a bin received by a load arm of the vehicle, according to an embodiment.

FIGS. 7(a) and 7(b) show a vehicle that is configured to detect the presence of an active beacon attached to a specific object within a bin received by a load arm of the vehicle, according to another embodiment.

FIGS. 8(a) and 8(b) show a vehicle that is configured to detect the presence of an active beacon attached to a specific object within a bin received by a load arm of the vehicle, according to another embodiment.

FIG. 9 shows a flow chart that includes steps of a method of detecting the presence of an active beacon attached to a specific object within a bin received by a load arm of a vehicle, according to an embodiment.

### DETAILED DESCRIPTION

The embodiments described include methods, apparatuses, and systems for detecting the presence of an active tag attached to a battery within a bin received by a vehicle.

Active radio beacons are used for identification and location of objects. In typical applications for active beacons, the beacon is powered from a very small battery such as a coin cell, from a photovoltaic source, or some other very limited power source, representing a serious limitation on the ability of the beacon to transmit. However, if an active beacon is employed to identify a hazardous battery, the task of the beacon is to identify a battery with sufficient capacity to represent a significant flammability threat. The capacity of such batteries is generally in the range of a watt-hour or greater. For detection scenarios relevant to recycling fire safety, a beacon may be sent up to 5 times per second. The power associated with transmission is approximately 0.2 milliW. Typical small 18650 lithium cells (roughly the smallest size that might be considered as representing a flammability hazard) have capacities exceeding 1 A-h or 3.5 W-h. The resulting endurance for a beacon attached to a single 18650 cell is approximately 2 years, and in almost all relevant cases a number of cells would be placed in a single battery rack. Thus, the beacon represents a completely insignificant additional load for any large battery pack, and plays a negligible role in overall battery power consumption for typical high-power applications, while remaining active for identification use until long after the final battery charging operation.

Single-cell lithium ion batteries have an output voltage exceeding 3 volts until the state of charge has fallen to well below 10%. FIG. 2 shows a typical example of voltage vs. state of charge, according to an embodiment.

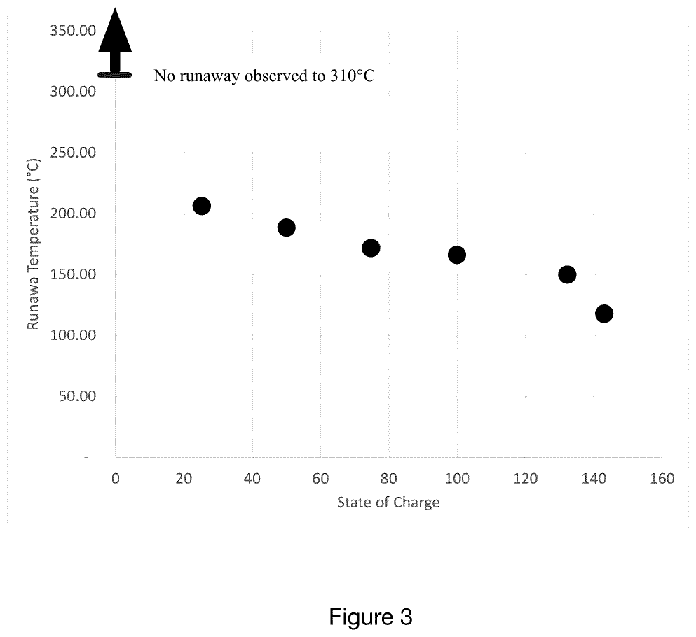

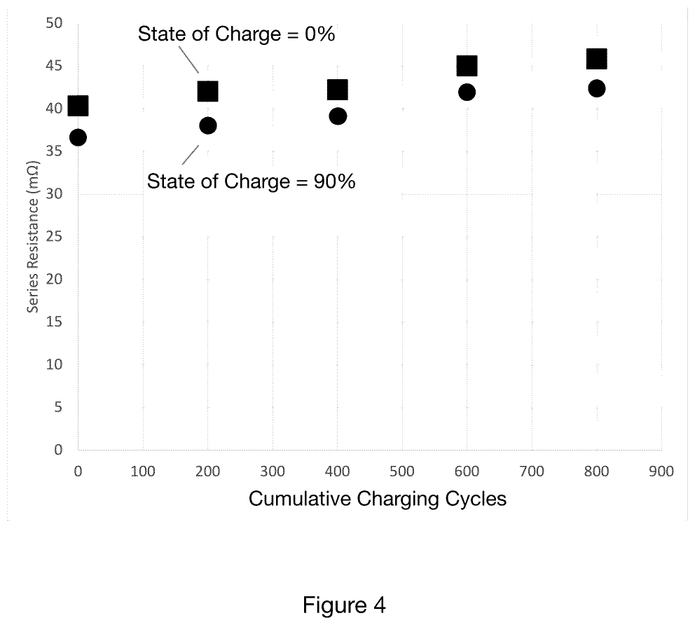

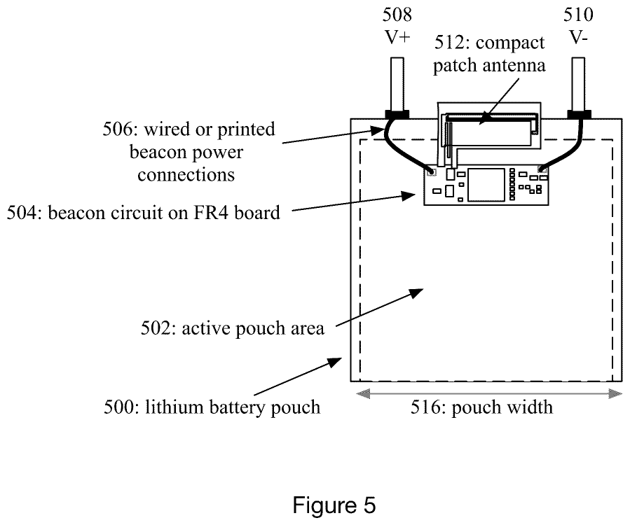

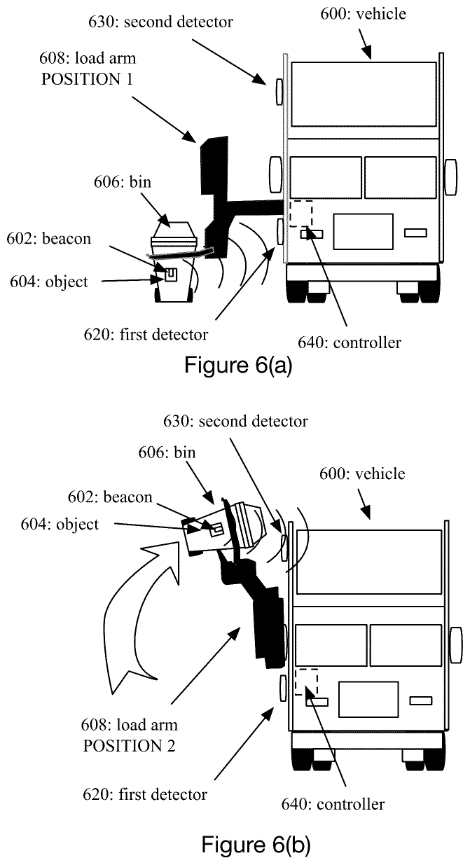

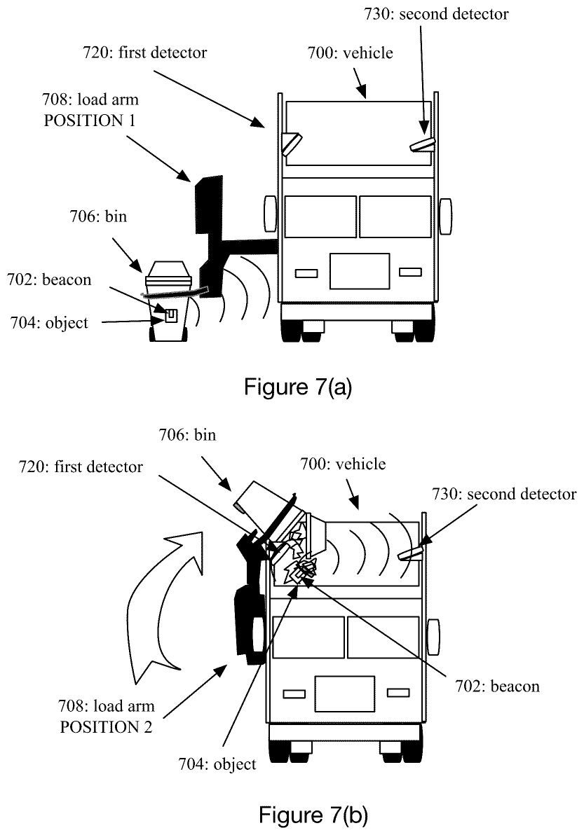

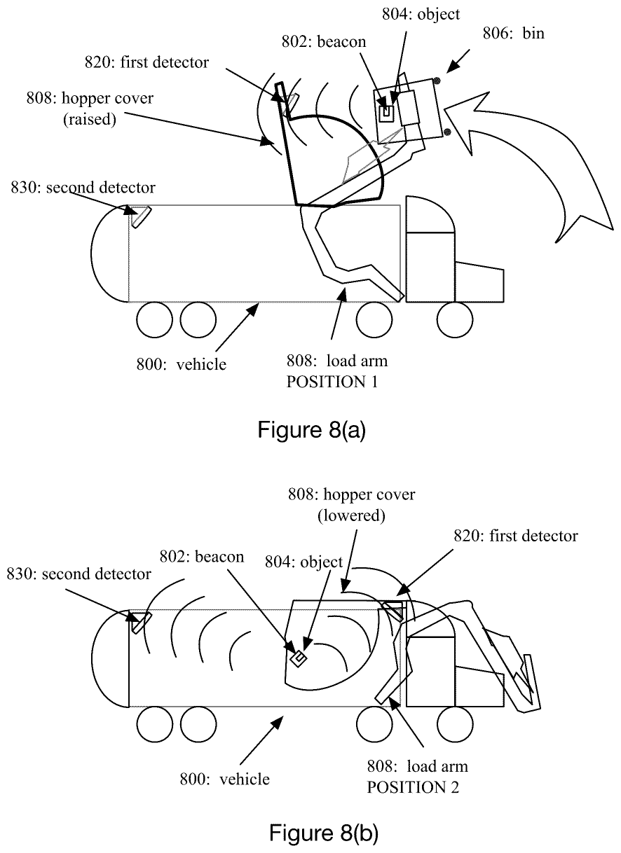

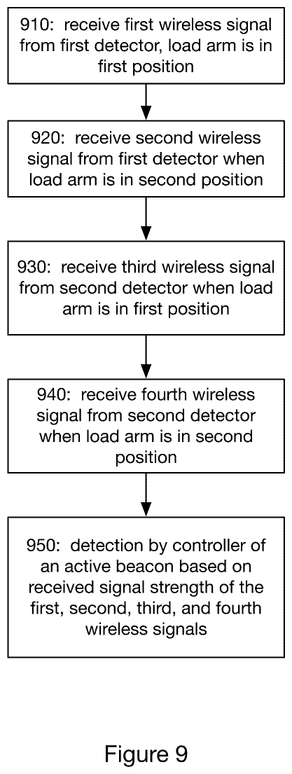

The hazard from a battery is greatly reduced when the state of charge is below 10%. For example, FIG. 3 shows the behavior of conventional 18650 battery cells as the temperature is ramped at a slow rate (2° C. per minute in this case), according to an embodiment. Thermal runaway at 25% state of charge is not observed until more than twice the ramp time for a fully-charged battery, and is not observed at all for state of charge=0. Therefore it is apparent that any lithium ion battery cell that has sufficient state of charge to represent a significant thermal hazard will product at least 3 volts at its terminals, typically sufficient for an active radio beacon to operate. Analogous behavior is expected for larger packs consistent of multiple cells connected in series or parallel.

Low states of charge are associated with increased internal battery resistance, but the increase is modest. FIG. 3 show an internal battery resistance for Panasonic 18650 lithium ion cell, according to an embodiment. The internal resistance of a battery that has experienced multiple charging cycles and is nearly discharged has risen to about 46 milliOhms, compared to the minimum observed value of about 36 milliOhms. If a beacon draws a current on the order of 10 mA when it is transmitting, the associated voltage drop is approximately 0.5 mV, and is negligible compared to the voltage margin available for a typical beacon, which requires on the order of 1.2 volts to operate.

It is therefore apparent that a typical low-power radio beacon powered by any large lithium ion battery is capable of transmitting a warning beacon any time the battery represents a significant flammability hazard. However, in order to assure detection when needed, beacons can transmit at power levels that provide tens or even hundreds of meters of detection range in open space, and many more batteries will be in use at any given time than in recycling or disposal streams. Therefore, if batteries are marked with continuously-broadcasting active beacons, means for distinguishing between beacons in the collected recycling or disposal stream and those in the outside ambient are needed.

In order to reliably detect and locate flammable lithium batteries before a fire can occur, at least some of the disclosed embodiments employ an active beacon transmitter powered by the lithium ion battery. At least some of the described embodiments presume industrial and regulatory agreement to attach such beacons to all lithium ion batteries regarded as representing a significant flammability risk at end-of-life. This approach depends on the fact that lithium ion batteries large enough to represent a substantial fire risk have high total energy capacity and are used to power large systems with substantial power requirements. A radio beacon powered by the battery can transmit continuously through the life of the battery, without representing a significant drain on its capacity in comparison to the intended loads. It is well known that the flammability risk of a battery is dependent on the state of charge (SOC). Thus, if the beacon is designed so as to operate at least until the state of charge has fallen to a safe level, indicated by a low battery output voltage provided to the beacon, the beacon will provide a warning as long as the battery is dangerous.

Any or all of trucks (vehicles) collecting recycled materials, tipping floors where recycled materials are dumped for processing, and conveyorized lines where materials are separated, can be equipped with receivers capable of detecting beacon signals indicating the presence of a potentially hazardous lithium ion battery. In order to detect only hazardous batteries which are included in the recycling stream, the disclosed embodiments include specific antenna configurations that are proposed for trucks (vehicles) collecting recycled materials. Various methods can then be used to locate and remove the hazardous battery, reducing fire risk and optionally permitting safe recycling of the battery itself.

A precondition for practice of the described embodiments is the application of industry-standard active beacons to substantially all hazardous lithium ion batteries. A wide variety of commercial radio beacon chips and packaged parts exist, typically operating under standard communications protocols. The active tags (active beacons) of the described embodiments can be based on the Bluetooth Low Energy (BTLE) standard, but other protocols, such as IEEE 802.11 (Wi-Fi) or 802.15, could be used. Each protocol offers differing benefits for identifying hazardous batteries, but agreement upon a single protocol is an optimal precondition for reliable detection.

A BTLE beacon can be configured to transmit a beacon periodically. Beacon packets can contain up to 37 bytes of payload (296 bits), which is easily sufficient to contain a unique identifier. Various standards exist for defining beacon format; for example, the Eddystone-UID format provides a unique identifier for a beacon transmitter. While not indispensable to the practice of the described embodiments, it is helpful to obtain agreement from the relevant standards and industry organizations upon a unique identification (UID) for beacons, to unambiguously indicate the presence of an attached hazardous lithium ion battery. In this fashion, a receiver could search specifically for hazardous batteries from amongst the various BTLE beacons it might receive.

FIG. 4 shows an exemplary active beacon 504 and antenna 512 mounted on a typical lithium ion pouch battery 500, according to an embodiment. The core of the beacon 504 is an integrated circuit, typically packaged as a wafer-level chip-scale package, or a standard component package. A high-precision frequency reference, typically a quartz crystal, is needed to ensure accurate frequency control of transmissions and compliance with FCC regulations for unlicensed operation. Discrete capacitors, resistors, and optionally inductors may be used for filtering inputs and outputs. The resulting sizes for beacon circuit boards 504 vary from about 2-4 cm by 1-4 cm, and can easily be fit within the size of a typical large pouch battery 500. Robust electrical connections 506, either wired or printed, must be provided, so that the beacon is powered (by V+ 508 and V− 510 of the lithium ion pouch battery 500) whenever the battery state of charge is sufficient to represent a flammability hazard. The lithium ion pouch battery 500 includes an active pouch area 502 and pouch width 516. Beacons may be attached to larger battery packs with higher output voltages. Beacons may be wired to employ only a portion of the full battery pack at an appropriate voltage, or voltage conversion techniques can be used to reduce the applied voltage from the full pack to an appropriate voltage for the beacon circuitry.

For an embodiment, the active beacon (such as the exemplary beacon and antenna of FIG. 5) is powered by the potentially hazardous battery (such as the lithium ion pouch battery 500) it is intended to identify, providing a transmitted signal by the active beacon when the battery has sufficient state of charge to represent a flammability hazard. That is, for this embodiment, the active beacon is attached to, and powered by, the battery.

An antenna must be provided for signal transmission. The BTLE standard operates in the 2.45 GHz range, where wavelength is approximately 12 cm. Effective antennas can be constructed in a space on the order of 2-4 cm on a side or less.

Thus, a beacon can be physically small enough to conveniently attach to any battery pack or pouch large enough to represent a substantial hazard. The beacon may be configured to transmit at periodic intervals as long as it is active and powered. The optimal beacon transmit period varies slightly depending on the recycling operation at which the beacon is to be detected, but in all cases except high-speed conveyorized sorting, a beacon period 0.2 to 1 second should be sufficient to provide a received with adequate warning of the presence of a potentially hazardous battery. As noted above, transmission of beacons at these periods represents a very small load for large battery packs. Transmit power in typical commercial beacons may be adjusted to as low as −40 dBm, and as high as +5 dBm. However, transmission at power less than about −15 to −20 dBm would fail to ensure detection, particularly in cases where the transmit antenna is occluded by neighboring materials (e.g. aluminum foil) or damaged. Transmission at 0 to +5 dBm is preferred for reliable detection of hazardous batteries, but will provide ranges of tens of meters, resulting in the likelihood of false positive detection from ambient beacons.

Thus, it is practical to attach a beacon to any battery pack large enough to represent a flammability hazard, without impacting the endurance of the supported equipment. In an embodiment, the beacon integrated circuit and reference oscillator may be incorporated into a flexible substrate, upon which the antenna is printed by standard metal deposition/etch or additive manufacturing. The battery pack must then be modified to incorporate mechanical support for the beacon, and electrical connection to the active terminals of the battery. In the case where a battery pack is composed of multiple pouches, and where each individual pouch is large enough to represent a substantial flammability hazard, a beacon may be attached to each pouch. If a beacon becomes detached from the battery pack, it has no power source and will not transmit, avoiding false positive detection errors.

In the case where active beacons have been attached to substantially all hazardous batteries, it is then necessary to detect the presence of these beacons, and distinguish between beacons that correspond to hazardous batteries collected in a recycling or disposal stream, and other batteries in normal use. Simple and reliable means of location must be employed to determine when a detected beacon arises from the collected recycling or disposal materials.

FIGS. 6(a) and 6(b) show a vehicle 600 that is configured to detect the presence of an active beacon 602 attached to a specific object 604 within a bin 606 received by a load arm 608 of the vehicle 600, according to an embodiment. As shown, the vehicle 600 includes the load arm 608 configured to receive the bin 606. Further, the vehicle 600 includes a first detector 620 oriented relative to the load arm 608 to receive a first wireless signal when the load arm 608 is in a first position P1 (POSITION 1 of FIG. 6(a)) and receive a second wireless signal when the load arm 608 is in a second position P2 (POSITION 2 of FIG. 6(b)). Further, the vehicle 600 includes a second detector 630 oriented relative to the load arm 608 to receive a third wireless signal when the load arm 608 is in the first position P1 and receive a fourth wireless signal when the load arm 608 is in the second position P2. Further, the vehicle 600 includes a controller 640 configured to detect presence of the active beacon 602 attached to the specific object 604 within the bin 606 based on the received signal strengths of the first wireless signal, the second wireless signal, the third wireless signal and the fourth wireless signal.

It is to be understood that various relationships between the received signal strengths of the first wireless signal, the second wireless signal, the third wireless signal and the fourth wireless signal can be analyzed to determine the presence of the active beacon 602. For an embodiment, the controller 640 is further configured to detect presence of the active beacon 602 attached to the specific object 604 within the bin 606 when a change between the received signal strengths of the first wireless signal, the second wireless signal, and a change between the received signal strengths of third wireless signal and the fourth wireless signal are greater than a preselected threshold. For an embodiment, preselected threshold is selected by experimental testing reception of the wireless signals of the active beacon against beacons not located in the bin. For an embodiment, the change in the first and second wireless signals received by the first detector from position 1 to position 2, and the change in the third and fourth wireless signals received by the second detector from position 1 to position 2, are both larger than a threshold and are opposite in sign, That is, the changes in the first and second wireless signals received by the first detector are anti-correlated with the third and fourth wireless signals received by the second detector.

For an embodiment, in order to reduce the number of false positive detections in the presence of the active tag, for an embodiment, the controller 640 is further configured to confirm the detected presence of the active beacon. For an embodiment, confirming the detected presence of the active beacon includes the controller 640 being configured to control additional rotation of the load arm 608 and confirm the detected presence based on additional signals sensed by the first and second detectors 620, 630. For an embodiment, the confirmation includes the controller 640 being further configured to control additional lift of the load arm 608 and confirm the detected presence based on additional signals sensed by the first and second detectors 620, 630.

For an embodiment, the controller is further configured to detect presence of the active beacon attached to the specific object within the bin when a difference in received signal strength between the first wireless signal and the second wireless signal is greater than a difference in received signal strength between the third wireless signal and the fourth wireless signal.

For at least some embodiments, the bin 606 is made of a non-metallic material. This ensures that the first detector 620 and the second detector second detector 630 can receive the wireless signals from the active beacon 602.

For an embodiment, it is assumed that the first wireless signal received by the first detector 620 and the third wireless signal received by the second detector 630 originated (transmitted from) from the active beacon 602 when the load arm 608 is in the first position P1. However, it is to be understood that an alternate embodiment includes the load arm 608 being in a third position P3 that is different than the first position P1 when the wireless signal is transmitted from the active beacon 602 and results in the third wireless signal received by the second detector 630. Further, for an embodiment, it is assumed that the second wireless signal received by the first detector 620 and the fourth wireless signal received by the second detector 630 originated (transmitted from) from the active beacon 602 when the load arm 608 is in the second position P2. However, it is to be understood that an alternate embodiment includes the load arm 608 being in a fourth position P4 that is different than the second position P2 when the wireless signal is transmitted from the active beacon 602 and results in the fourth wireless signal received by the second detector 630.

For an embodiment, the active beacon 602 is configured to transmit wireless signals. For an embodiment, the active beacon 602 is a previously described beacon and antenna mounted on typical lithium ion battery. For an embodiment, the active beacon includes an identifying number, and the identifying number comprises a specific sequence indicating presence of a hazardous battery. For an embodiment, the active beacon periodically transmits wireless signals.

For an embodiment, the first detector 620 and the second detector 630 are each a previously described Bluetooth Low Energy (BTLE) receiver.

As shown in FIG. 6, for an embodiment, the second detector 630 is located proximate to a tipping position 640 of the load arm load arm 608, and the first detector 620 is located proximate to a lowest position 650 of the load arm 608.

As previously described, for an embodiment, the first wireless signal received by the first detector 620 and the third wireless signal received by the second detector 630 originated (transmitted from) from the active beacon 602 when the load arm 608 is in the first position P1. That is, for an embodiment, the first wireless signal and the third wireless signal originate from the active beacon attached to the specific object but propagate through different transmission paths. It is to be understood that many propagation paths will typically exist for both the first wireless signal and the third wireless signal, but the propagation paths for each will be different. Similarly, for an embodiment, the second wireless signal and the fourth wireless signal originate from the active beacon attached to the specific object but propagate through different transmission paths.

For an embodiment, the specific object is a battery, and the active beacon receives electrical power from the battery. That is, for an embodiment, the specific object being detected is the battery, and more specifically for an embodiment, the active beacon is attached to and powered by the battery the active beacon is attached to. As described, the battery is only potentially dangerous when the battery is still carrying a charge. Therefore, the active beacon only transmits wireless signals when the battery is still carrying a charge and potentially dangerous.

An implementation of the embodiment of FIG. 6 includes a detection apparatus for active beacons (such as, active beacon 602) in plastic collection bins (such as bin 606) when those bins are collected by a side-loader collection truck (vehicle 600). The detection apparatus employs two directional antennas (the first detector 620 and the second detector 630) mounted to the side of the collection truck (vehicle 600), one (first detector 620) at the level of the bin 606 when initially picked up by the container arm (load arm 608), and a second antenna (second detector 630) at a higher level where it primarily views the path of the bin 606 as the bin 606 is raised to be dumped into the side-loader truck (vehicle 600). The antennas (the first detector 620 and the second detector 630) may be connected to a single receiver and used alternately, or each antenna (the first detector 620 and the second detector 630) may be connected to a separate receiver. The active beacon 602 indicating the presence of a hazardous battery or pack in the bin 606 will be received by both antennas (the first detector 620 and the second detector 630). The received signal strength will vary in a fashion that corresponds to the lift path in the truck (vehicle 600). Other signals from beacons present in the surroundings, such as phones or laptop computers carried by pedestrians or within cars or public transit, within homes, or in industrial settings, will have a received signal strength that is very unlikely to be correlated to the lift operation (change in the positions (such as, positions P1, P2) of the load arm 608) in a similar fashion. Therefore, it is straightforward to employ automated techniques to recognize that an active beacon 602 representing a potential flammability hazard is in fact contained within the bin 606. Once that is determined, the truck (vehicle 600) driver may be warned and enabled to return the bin 606 to ground level and check for the hazardous battery. The check may optionally involve such means as a handheld receiver with a directional antenna, or may simply involve return of the bin 606 until the user removes the hazardous materials.

For an embodiment, the load arm 608 is configured to rotate through a sequence of positions. The first detector and the second detector are configured measure received signal strengths of wireless signals received at each of the sequence of positions of the load arm. The controller is configured to multiply the received signal strength of each of the sequence of positions with a corresponding function of the angle of each of the sequence of positions to form a measure of correlation of a signal sequence and the sequence of positions, and detect and report the presence of the beacon when a magnitude of the measure of the correlation exceeds a correlation threshold for both the received signal strengths of the wireless signals received by the first detector and the second detector.

For an embodiment, the active beacon 602 is configured to transmit at a time interval such that multiple signals are received during a sequence of positions, and the sequence of received signal strength can be correlated with the sequence of positions for the first detector and the second detector. That is, the active beacon transmits the wireless signal frequently enough that different wireless signals can be detected at the first position and the second position

FIG. 7 shows a vehicle 700 that is configured to detect the presence of an active beacon 702 attached to a specific object 704 within a bin 706 received by a load arm 708 of the vehicle 700, according to another embodiment. As shown, for an embodiment, the first detector 720 is located and oriented to sense wireless signals of the active beacon 702 after contents of the bin 706 including the active beacon 702 has been dumped from the bin 706 and the second detector 730 is located and oriented to detect beacons during a lift operation of the load arm 708.

An implementation of the embodiment of FIG. 7 includes antennas (the first detector 720 and the second detector 730) placed on the sides of the interior of a side-loader truck (vehicle 700). One or more antennas are directed to receive signals primarily from the material being dumped from bins, and material previously received. One or more antennas are directed upwards, to receive signals primarily from outside the truck. By comparing RSSI history, signals from beacons contained in bins can be easily distinguished from those originating outside the truck (vehicle 700) and unrelated to the recycling collection operation. This approach has the advantage that the metallic walls of the side-loader truck (vehicle 700) will provide considerable shielding from ambient beacons, greatly reducing the likelihood that a beacon received from a transmitter elsewhere in the environment will be incorrectly identified as being in a bin 706 or in the truck (vehicle 700).

FIG. 8 shows a vehicle 800 that is configured to detect the presence of an active beacon 802 attached to a specific object 804 within a bin 806 received by a load arm 808 of the vehicle 800, according to another embodiment. For an embodiment, the second detector 830 is located within a hopper of the vehicle 800 and the first detector 820 is located on a pickup arm (load arm 808) or a hopper cover.

An implementation of the embodiment of FIG. 8 includes a front-loader truck (vehicle 800) equipped with one or more antennas (the first detector 820 and the second detector 830) contained within the enclosed collection area, and optional antennas on the hopper cover facing the dump path. A configuration with a hinged cover is shown; alternative front-loader configurations with sliding hopper covers may also be used, with appropriate modification to the antenna placement. The antennas that are contained in the collection area receive only beacons from transmitters (active beacons) contained within the collection area, particularly when the hopper cover is lowered. The optional antennas mounted on the hopper cover may detect beacons from the ambient during the collection operation, but the RSSI history during the dump operation, combined with that of the internal antennas, may be employed to identify beacons which are contained in the dumpster as it is dumped into the front-loader.

The embodiment of FIG. 8 provides very few false positive responses, as external beacons will rarely be detected when the hopper cover is closed.

FIG. 9 shows a flow chart that includes steps of a method of detecting the presence of an active beacon attached to a specific object within a bin received by a load arm of a vehicle, according to an embodiment. A first step 910 includes receiving, by a first detector of a vehicle, a first wireless signal when the load arm of the vehicle is in a first position. A second step 920 includes receiving, by the first detector, a second wireless signal when the load arm is in a second position. A third step 930 includes receiving, by a second detector of the vehicle, a third wireless signal when the load arm is in the first position. A fourth step 940 includes receiving, by the second detector, a fourth wireless signal when the load arm is in the second position. A fifth step 950 includes detecting, by a controller, the presence of an active beacon attached to a specific object within the bin based on the received signal strengths of the first wireless signal, the second wireless signal, the third wireless signal and the fourth wireless signal.

As previously described, an embodiment includes detecting the presence of the active beacon attached to the specific object within the bin when a change between the received signal strengths of the first wireless signal, the second wireless signal, and a change between the received signal strengths of the third wireless signal and the fourth wireless signal are greater than a preselected threshold. For an embodiment, preselected threshold is selected by experimental testing reception of the wireless signals of the active beacon against beacons not located in the bin. For an embodiment, the change in the first and second wireless signals received by the first detector from position 1 to position 2, and the change in the third and fourth wireless signals received by the second detector from position 1 to position 2, are both larger than a threshold and are opposite in sign, That is, the changes in the first and second wireless signals received by the first detector are anti-correlated with the third and fourth wireless signals received by the second detector.

As previously described, an embodiment includes confirming the detected presence of the active beacon, including controlling additional rotation of the load arm and confirm the detected presence based on additional signals sensed by the first and second detectors. As previously described, an embodiment includes confirming the detected presence of the active beacon, including controlling additional lift of the load arm and confirming the detected presence based on additional signals sensed by the first and second detectors.

As previously described, an embodiment includes detecting the presence of the active beacon attached to the specific object within the bin when a difference in received signal strength between the first wireless signal and the second wireless signal is greater than a difference in received signal strength between the third wireless signal and the fourth wireless signal.

As previously described, an embodiment includes the second detector being located proximate to a tipping position of the load arm, and the first detector being located proximate to a lowest position of the load arm. As previously described, an embodiment includes the first detector being located and oriented to sense wireless signals of the active beacon after contents of the bin including the active beacon have been dumped from the bin and the second detector being located and oriented to detect beacons during a lift operation of the load arm. As previously described, an embodiment includes the first detector being located within a hopper of the vehicle and the second detector being located on a pickup arm or a hopper cover.

As previously described, for an embodiment the active beacon is configured to transmit wireless signals. For an embodiment, the first wireless signal and the third wireless signal originate from the active beacon attached to the specific object but propagate through different transmission paths. For an embodiment, the second wireless signal and the fourth wireless signal originate from the active beacon attached to the specific object but propagate through different transmission paths. For an embodiment, the active beacon includes an identifying number, and the identifying number comprises a specific sequence indicating presence of a hazardous battery. For an embodiment, the active beacon periodically transmits wireless signals.

For an embodiment, the specific object comprises a battery, and the active beacon receives electrical power from the battery. As previously described, the active beacon only transmits wireless signals when the battery is carrying a charge and is potentially dangerous.

An embodiment further includes rotating the load arm through a sequence of positions, measuring by the first detector and the second detector received signal strengths of wireless signals received at each of the sequence of positions of the load arm, multiplying the received signal strength of each of the sequence of positions with a function of the corresponding angle of each of the sequence of positions to form a measure of correlation of a signal sequence and the sequence of positions, detecting and reporting presence of the beacon when a magnitude of the measure of the correlation exceeds a correlation threshold for both the received signal strengths of the wireless signals received by the first detector and the second detector.

For an embodiment, the active beacon is configured to transmit at a time interval such that multiple signals are received during a sequence of positions, and the sequence of received signal strength can be correlated with the sequence of positions for the first detector and the second detector. That is, the active beacon transmits the wireless signal frequently enough that different wireless signals can be detected at the first position and the second position

Although specific embodiments have been described and illustrated, the embodiments are not to be limited to the specific forms or arrangements of parts so described and illustrated. The described embodiments are to only be limited by the claims.

What is claimed:

1. A vehicle, comprising:
a load arm configured to receive a bin;
a first detector oriented relative to the load arm to receive a first wireless signal when the load arm is in a first position, and receive a second wireless signal when the load arm is in a second position;
a second detector oriented relative to the load arm to receive a third wireless signal when the load arm is in the first position, and receive a fourth wireless signal when the load arm is in the second position; and
a controller configured to detect presence of an active beacon attached to a specific object within the bin based on the received signal strengths of the first wireless signal, the second wireless signal, the third wireless signal and the fourth wireless signal.

2. The vehicle of claim 1, wherein the controller is further configured to detect presence of the active beacon attached to the specific object within the bin when a change between the received signal strengths of the first wireless signal, the second wireless signal, and a change between the received signal strengths of the third wireless signal and the fourth wireless signal are greater than a preselected threshold.

3. The vehicle of claim 1, wherein the controller is further configured to confirm the detected presence of the active beacon, comprising the controller configured to control additional rotation of the load arm and confirm the detected presence based on additional signals sensed by the first and second detectors.

4. The vehicle of claim 1, wherein the controller is further configured to control additional lift of the load arm and confirm the detected presence based on additional signals sensed by the first and second detectors.

5. The vehicle of claim 1, wherein the controller is further configured to detect presence of the active beacon attached to the specific object within the bin when a difference in received signal strength between the first wireless signal and the second wireless signal is greater than a difference in received signal strength between the third wireless signal and the fourth wireless signal.

6. The vehicle of claim 1, wherein the second detector is located proximate to a tipping position of the load arm, and the first detector is located proximate to a lowest position of the load arm.

7. The vehicle of claim 1, wherein the first detector is located and oriented to sense wireless signals of the active beacon after contents of the bin including the active beacon has been dumped from the bin and the second detector is located and oriented to detect beacons during a lift operation of the load arm.

8. The vehicle of claim 1, wherein the second detector is located within a hopper of the vehicle and the first detector is located on a pickup arm or a hopper cover.

9. The vehicle of claim 1, wherein the active beacon is configured to transmit wireless signals.

10. The vehicle of claim 1, wherein the first wireless signal and the third wireless signal originate from the active beacon attached to the specific object but propagate through different transmission paths.

11. The vehicle of claim 1, wherein the second wireless signal and the fourth wireless signal originate from the active beacon attached to the specific object but propagate through different transmission paths.

12. The vehicle of claim 1, wherein the active beacon comprises an identifying number, and the identifying number comprises a specific sequence indicating presence of a hazardous battery.

13. The vehicle of claim 1, wherein the active beacon periodically transmits wireless signals.

14. The vehicle of claim 1, wherein the specific object comprises a battery, and the active beacon receives electrical power from the battery.

15. The vehicle of claim 1, wherein
the load arm is configured to rotate through a sequence of positions,
the first detector and the second detector are configured measure received signal strengths of wireless signals received at each of the sequence of positions of the load arm,
and the controller is configured to multiply the received signal strength of each of the sequence of positions with a function of a corresponding angle of each of the sequence of positions to form a measure of correlation of a signal sequence and the sequence of positions; and
detecting and reporting presence of the beacon when a magnitude of the measure of the correlation exceeds a correlation threshold for both the received signal strengths of the wireless signals received by the first detector and the second detector.

16. A method of detecting presence of an active beacon attached to a specific object within a bin received by a load arm of a vehicle, comprising:
receiving, by a first detector of a vehicle, a first wireless signal when the load arm of the vehicle is in a first position;
receiving, by the first detector, a second wireless signal when the load arm is in a second position;
receiving, by a second detector of the vehicle, a third wireless signal when the load arm is in the first position;
receiving, by the second detector, a fourth wireless signal when the load arm is in the second position; and
detecting, by a controller, the presence of an active beacon attached to a specific object within the bin based on the received signal strengths of the first wireless signal, the second wireless signal, the third wireless signal and the fourth wireless signal.

17. The method of claim 16, wherein detecting the presence of the active beacon attached to the specific object within the bin when a change between the received signal strengths of the first wireless signal, the second wireless signal, and a change between the received signal strengths of the third wireless signal and the fourth wireless signal are greater than a preselected threshold.

18. The method of claim 16, further comprising confirming the detected presence of the active beacon, comprising additionally rotating the load arm and confirming the detected presence based on additional signals sensed by the first and second detectors.

19. The method of claim 16, further comprising controlling additional lift of the load arm and confirming the detected presence based on additional signals sensed by the first and second detectors.

20. The method of claim 16, further comprising detecting the presence of the active beacon attached to the specific object within the bin when a difference in received signal strength between the first wireless signal and the second wireless signal is greater than a difference in received signal strength between the third wireless signal and the fourth wireless signal.
